(19) United States
(12) Patent Application Publication
(10) Pub. No.: US 2007/0138883 A1
(43) Pub. Date: Jun. 21, 2007

(54) Coupling mechanism of motor coil

(75) Inventor: Gyu-Hong Cho, Seoul (KR)

Correspondence Address: BACON & THOMAS, PLLC, 625 SLATERS LANE, FOURTH FLOOR, ALEXANDRIA, VA, 22314, US

(73) Assignee: DAEWOO ELECTRONICS Corporation, Seoul (KR)

(21) Appl. No.: 11/641,834

(22) Filed: Dec. 20, 2006

(30) Foreign Application Priority Data
Dec. 21, 2005 (KR) 10-2005-0126852

(51) Int. Cl. H02K 11/00

(52) U.S. Cl. 310/71; 310/68 R

(57) ABSTRACT

A coupling mechanism for coupling a coil wounded around a stator of a motor assembly to a circuit pattern of a printed circuit board, includes a plurality of connecting pins for electrically connecting the coil to the circuit pattern of the printed circuit board. The coil is indirectly connected to the circuit pattern through said one or more connecting pins. Further, the connecting pins are fixed at the PCB to be protruded outward.

### FIELD OF THE INVENTION

The present invention relates to a coupling mechanism of a coil of a motor; and, more particularly, to a coupling mechanism of a coil of a motor, which allows an easy electric connection and fixation of the coil to a printed circuit board (PCB).

### BACKGROUND OF THE INVENTION

In general, a motor is a device that generates a rotary power by converting electric energy into mechanical energy, and it is widely employed in industrial apparatus as well as in various household electronic appliances.

Below, a conventional motor will be described with reference to FIGS. 1 to 3.

FIG. 1 is a plan view showing a stator and a coil of a conventional motor assembly 10, and FIG. 2 is a plan view showing a PCB of the motor assembly 10. As shown in the figures, the motor assembly 10 includes a cylindrical stator 12 fixed inside a shell 11; a coil 13 wound around the stator 12; a rotor 14 rotatably provided inside the stator 12; and a PCB 15 installed at one side of the stator 12, for controlling a flow of electric currents to the coil 13.

The shell 11 forms a casing of the motor assembly 10, and, if required, a cover (not shown) can be detachably attached to either one side or each of both sides of the shell 11 to open and close the inside of the shell 11.

The stator 12 is made up of a multiple thin silicon steel plates laminated on top of each other. A plurality of teeth 12a extends from the inner cylindrical surface of the stator 12 toward the center while maintaining a preset distance from each other. This allows slots 12b to be formed between the teeth 12a. Further, an insulator 12c is provided on the outside of the teeth 12a and the coil 13 is wounded around each of the teeth 12a insulated by the insulator 12c.

The coil 13 is coupled to the PCB 15 and electric currents are passed through the coil 13 to generate a magnetic field. In case of a single-phase coil, two coil ends are respectively coupled to connection portions of the PCB 15 electrically and, in case of three-phase coils as shown in FIG. 1, three ends C₁, C₂ and C₃ of the coil 13 are respectively coupled to the connection portions of the PCB 15 electrically.

The rotor 14 has a shaft 14a fixed at its central portion, wherein the shaft 14a is installed in the shell 11 via a bearing (not shown) in a rotatable manner. The rotor 14 is rotatably installed inside the stator 12 with a gap intervened therebetween. A conductor (not shown) or permanent magnets (not shown) can be additionally employed depending on the type of the motor assembly 10.

The PCB 15 has, e.g., a circuit pattern 15a (see FIG. 3) and electric devices 15b provided on both sides thereof, wherein the circuit pattern 15a and the electric devices 15b are for controlling (e.g., switching) the flow of the electric currents to the coil 13. Further, as shown in FIG. 3, the edge of the PCB 15 is fitted to brackets 12d which are protrusively installed on the insulator 12c. This permits the PCB 15 to be fixed to the upper end side of the stator 12. The ends C₁, C₂ and C₃ of the coil 13 are respectively coupled to connection portions of the circuit pattern 15a electrically by soldering (S).

In the conventional configuration of the motor assembly 10, however, the interval between the stator 12 and the PCB 15 has been set narrow for the purpose of using a limited in-motor space effectively, as illustrated in FIG. 3. Thus, it has been difficult to solder the coil 13 to the circuit pattern 15a of the PCB 15, and there has been a high likelihood that the adjacent electric devices 15b are damaged by a high temperature of a soldering iron during the soldering process. Furthermore, since the coil 13 is soldered to the substantially planar circuit pattern 15a, it has been difficult to maintain proper solder amount for the precise electric connection and stable fixation of the coil 13 to the circuit pattern 15a. Thus, a carelessness of an operator would result in a failure in achieving a precise electric connection and fixation of the coil 13 to the circuit pattern 15a.

### SUMMARY OF THE INVENTION

It is, therefore, an object of the present invention to provide a coupling mechanism of a motor coil, capable of allowing the motor coil to be connected and fixed to a PCB easily and firmly by electrically coupling the coil to connecting pins wherein the connecting pins are connected with the PCB and exposed outward therefrom.

In accordance with an embodiment of the present invention, there is provided a coupling mechanism for coupling a coil wounded around a stator of a motor assembly to a circuit pattern of a printed circuit board, the coupling mechanism including: a plurality of connecting pins for electrically connecting the coil to the circuit pattern of the printed circuit board, wherein the coil is indirectly connected to the circuit pattern through said one or more connecting pins.

### BRIEF DESCRIPTION OF THE DRAWINGS

The above and other objects and features of the present invention will become apparent from the following description of preferred embodiments, given in conjunction with the accompanying drawings, in which:

FIG. 1 is a plan view illustrating a stator and a coil of a conventional motor assembly;

FIG. 2 sets forth a plan view illustrating a PCB of the conventional motor;

FIG. 3 presents a side view illustrating a conventional coupling mechanism of the motor coil assembly;

FIG. 4 provides a side view illustrating a coupling mechanism of a motor coil assembly in accordance with an embodiment of the present invention;

FIG. 5 depicts a plan view illustrating a PCB of the coupling mechanism of the motor in accordance with the embodiment of the present invention; and

FIG. 6 illustrates an expanded view of part “A” shown in FIG. 5.

### DETAILED DESCRIPTION OF THE EMBODIMENTS

Hereinafter, an exemplary embodiment of the present invention will be descried in detail so that the present invention can be easily implemented by those skilled in the art.

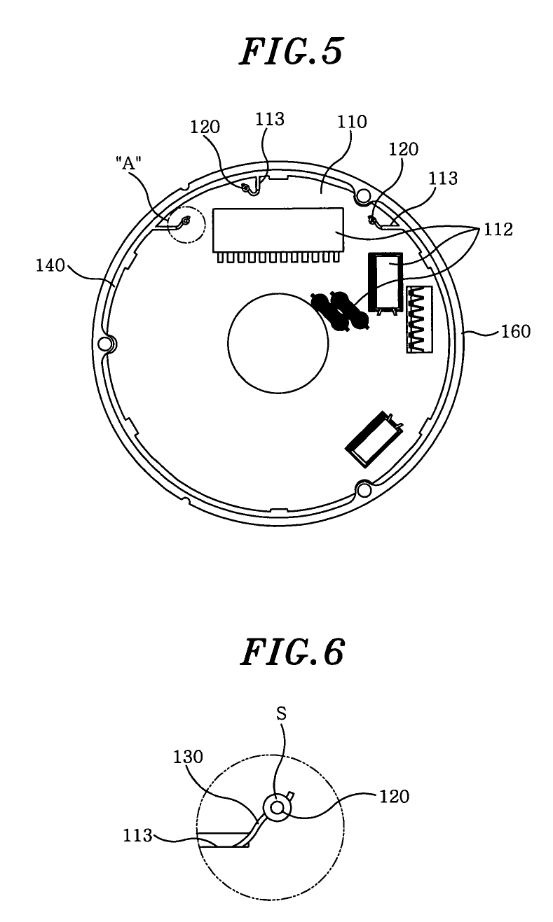

FIG. 4 is a side view showing a coupling mechanism 100 of a motor coil assembly in accordance with the embodiment of the present invention wherein only one half of the motor coil assembly is depicted and the other half is configured symmetrically in correspondence thereto. FIG. 5 is a plan view illustrating a PCB of the coupling mechanism 110 of the motor coil assembly. As for the coupling mechanism 100 shown in FIGS. 4 and 5, a number of connecting pins(only one shown) 120 electrically connected with a circuit pattern 111 are inserted through a printed circuit board(PCB) 110 to be protruded outward therefrom and firmly fixed thereat, and a coil 130 is electrically coupled to the connecting pins 120.

The PCB 110 is fixed to the upper side of a stator 150 with its edge fitted to a plurality of brackets 141 installed on an insulator 140 which is used for the insulation of a stator 150. Furthermore, the PCB is provided on its both sides with the circuit pattern 111 and electric devices 112 for controlling a flow of electric current to the coil 130.

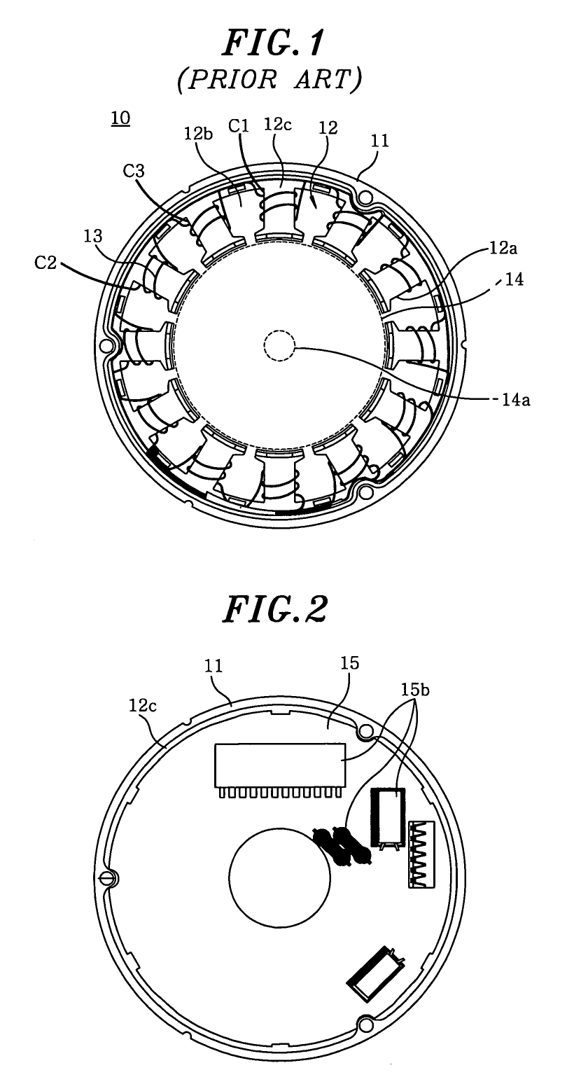

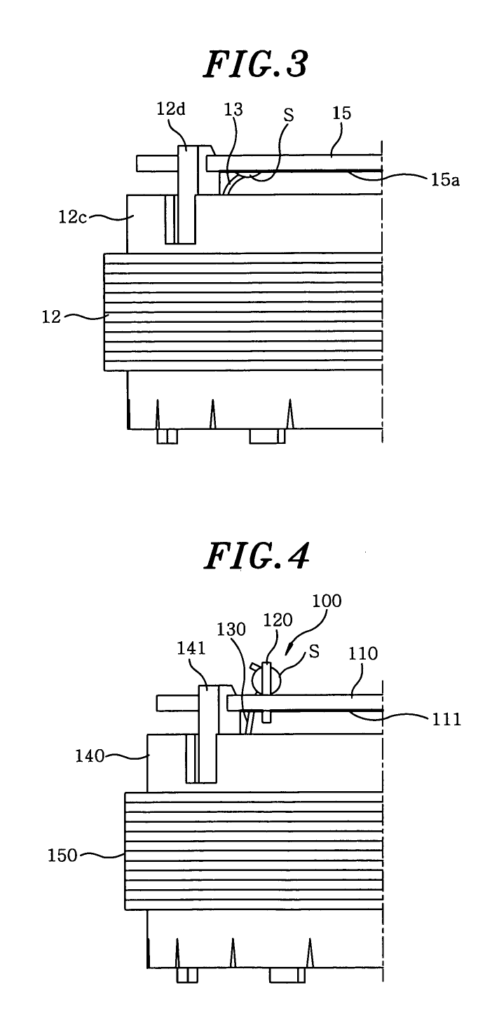

The coil 130 is wound around each of teeth 12a (see FIG. 1) of the stator 150 while interposing the insulator 140 for their insulation therebetween, and ends of the coil 130 are extracted to be connected and fixed to the circuit pattern 111 of the PCB 110.

The connecting pins 120 includes conductors, and they are inserted into insertion holes (not shown) respectively provided at connection portions (not shown) for the connection with the coil 130. Further, the connecting pins 120 are fixed in the insertion holes such that they are protruded outward in a direction opposite to where the stator 150 is located. This helps the coil 130 to be electrically connected with the circuit pattern 111 of the PCB 110 with ease. In addition, the circuit pattern 111 of the PCB 110 is formed extended up to the insertion holes, where the connecting pins 120 are inserted, to be electrically connected with the connecting pins 120. For the precise connection with the coil 130, the circuit pattern 111 can be extended up to the inside of the insertion holes or can be joined to the connecting pins 120 by soldering.

The coil 130 can be connected and fixed to the connecting pins 120 by using separate connection conductors fitted to the external sides of the connecting pins 120. Preferably, an end of the coil 130 is wound around the outwardly exposed portion of each connecting pin 120 and then is fixed thereat by soldering (S). Accordingly, the electric connection and fixation of the coil 103 to the connecting pins 120 is facilitated, while it is possible to secure the coil in place firmly.

The PCB 110 is provided at its edge portion with a number of coil insertion recesses 113. As shown in FIG. 6, the coil insertion recesses 113 serve to hold the coil 130 in place primarily when the coil 130 is coupled to the connecting pins 120, thus easing the connection between the coil 130 and the connecting pins 120 and also preventing once fixed coil 130 from being separated from the connecting pins 120 by an undesired external force.

The coil insertion recesses 113 are formed to be extended from the edge portion of the PCB 110 up to the connecting pins 120, thus allowing the coil 130 inserted therethrough to reach the connecting pins 120 from outside.

The coupling mechanism 100 of the motor coil assembly configured as described above is operated as follows.

To connect the ends of the coil 130 wounded the stator 150 to the PCB 110 electrically, the coil 130 are inserted into the coil insertion recesses 113 of the PCB 110 to be brought close to the connecting pins 120 which are electrically connected with the circuit pattern 111 of the PCB 110. Thereafter, while maintaining the coil 130 on the connecting pin 120's outwardly exposed portions or after wounding the coil 130 around those exposed portions of the connecting pins 120, soldering (S) is performed so that the ends of the coil 130 are connected and fixed to the connection portions of the circuit pattern 111. As a result of the coil 130 being connected to the PCB 110, the flow of electric currents to the coil 130 can be controlled by the PCB 110.

Further, prior to connecting the coil 130 to the PCB 110, the coil 130 is inserted into the coil insertion recesses 113, whereby the coupling of the coil 130 and the connecting pins 102 is facilitated, and the coil 130 can prevented from being separated from the connecting pins 120 by an undesired external force.

Moreover, by wounding the coil 130 around the outwardly exposed connecting pins 120 and soldering the coil 130 thereto, the coil 130 can be coupled to the PCB 110 readily, while its fixation to the PCB 110 is further enhanced.

As described above, in the coupling mechanism of the motor coil assembly in accordance with the embodiment of the present invention, the coil is electrically coupled to the PCB through the connecting pins which are connected to the PCB electrically and exposed outward therefrom. Thus, the electric connection and fixation of the coil to the PCB can be facilitated, and the coil can be fixed to the PCB more firmly.

While the invention has been shown and described with respect to the embodiment, it will be understood by those skilled in the art that various changes and modifications may be made without departing from the spirit and scope of the invention as defined in the following claims.

What is claimed is:

1. A coupling mechanism for coupling a coil wounded around a stator of a motor assembly to a circuit pattern of a printed circuit board, the coupling mechanism comprising:
a plurality of connecting pins for electrically connecting the coil to the circuit pattern of the printed circuit board, wherein the coil is indirectly connected to the circuit pattern through said one or more connecting pins.

2. The coupling mechanism of claim 1, wherein the printed circuit board is provided with one or more insertion hole through which the connecting pins are inserted.

3. The coupling mechanism of claim 1, wherein said one or more connecting pins are inserted through the PCB to be protruded outward and fixed thereat.

4. The coupling mechanism of claim 3, wherein the coil is soldered to outwardly exposed portions of the connecting pins.

5. The coupling mechanism of claim 1, wherein the PCB has a plurality of coil insertion recesses provided at an edge portion thereof, for guiding the coil to the connecting pins.
